(19) United States
(12) Patent Application Publication
(10) Pub. No.: US 2025/0365780 A1
(43) Pub. Date: Nov. 27, 2025

(54) WIRELESS TRANSCEIVER DEVICE, TRANSMISSION POWER CONTROL METHOD THEREOF, AND WIRELESS COMMUNICATION SYSTEM

(71) Applicant: Realtek Semiconductor Corporation, Hsinchu (TW)

(72) Inventors: Wen-Yung LEE, Hsinchu (TW); Chia-Yu HSU, Hsinchu (TW); Jhe-Yi LIN, Hsinchu (TW)

(21) Appl. No.: 19/198,146

(22) Filed: May 5, 2025

(30) Foreign Application Priority Data
May 27, 2024 (TW) 113119576

(51) Int. Cl. H04W 74/0833; H04L 5/00; H04W 52/36

(52) U.S. Cl. CPC H04W 74/085; H04L 5/0053; H04W 52/367

(57) ABSTRACT

A wireless transceiver device includes a communication module and a processor. The processor is used for performing the following operations: determining whether to perform an active spatial reuse transmission when detecting an overlapping basic service set packet; entering a backoff phase when determining that the active spatial reuse transmission is to be performed; pausing the backoff phase when detecting a data packet of which a destination is the wireless transceiver device before the backoff phase ends, and receiving the data packet; determining a lower one of a minimum transmission power of a response frame in response to the data packet and an active transmission power corresponding to the wireless transceiver device as a passive transmission power of the response frame; and transmitting the response frame with the passive transmission power in a short inter-frame space after the data packet is received.

### RELATED APPLICATIONS

This application claims priority to Taiwan Application Serial Number 113119576, filed May 27, 2024, which is herein incorporated by reference.

### BACKGROUND

### Technical Field

The present disclosure relates to spatial reuse transmissions, and more particularly to a wireless transceiver device that supports technologies such as spatial reuse and basic service set (BSS) coloring and has a passive spatial reuse transmission function, a transmission power control method thereof, and a wireless communication system.

### Description of Related Art

The IEEE 802.11ax standard specifies a spatial reuse mechanism, which aims to have wireless resources of the same frequency band of overlapped basic service sets (OBSSs) reusable for increasing the usage efficiency of the frequency band. However, because of the lack of transmission specifications for the passive spatial reuse, when the passive spatial reuse transmission is to be performed, the transmission failure may occur due to collisions or low power.

### SUMMARY

One aspect of the present disclosure directs to a wireless transceiver device which includes a communication module and a processor. The communication module is used for transmitting and receiving radio frequency signals, and the processor is coupled to the communication module and performs the following operations: determining whether to perform an active spatial reuse transmission when detecting an OBSS packet; entering a backoff phase when determining that the active spatial reuse transmission is to be performed; pausing the backoff phase when detecting a data packet of which a destination is the wireless transceiver device before the backoff phase ends, and receiving the data packet; determining a lower one of a minimum transmission power of a response frame in response to the data packet and an active transmission power corresponding to the wireless transceiver device as a passive transmission power of the response frame; and transmitting the response frame with the passive transmission power in a short inter-frame space (SIFS) after the data packet is received.

Another aspect of the present disclosure directs to a transmission power control method which is adapted to a wireless transceiver device and includes: determining whether to perform an active spatial reuse transmission when detecting an OBSS packet; entering a backoff phase when determining that the active spatial reuse transmission is to be performed; pausing the backoff phase when detecting a data packet of which a destination is the wireless transceiver device before the backoff phase ends, and receiving the data packet; determining a lower one of a minimum transmission power of a response frame in response to the data packet and an active transmission power corresponding to the wireless transceiver device as a passive transmission power of the response frame; and transmitting the response frame with the passive transmission power in a short inter-frame space after the data packet is received.

Yet another aspect of the present disclosure directs to a wireless communication system which includes a first wireless transceiver device and a second wireless transceiver device. The second wireless transceiver device is communicatively connected to the first wireless transceiver device, and constitutes a basic service set (BSS) with the first wireless transceiver device, and performs the following operations: determining whether to perform an active spatial reuse transmission when detecting an OBSS packet; entering a backoff phase when determining that the active spatial reuse transmission is to be performed; pausing the backoff phase when detecting a data packet from the first wireless transceiver device before the backoff phase ends, and receiving the data packet; determining a lower one of a minimum transmission power of a response frame in response to the data packet and an active transmission power corresponding to the second wireless transceiver device as a passive transmission power of the response frame; and transmitting the response frame to the first wireless transceiver device with the passive transmission power in a short inter-frame space after the data packet is received.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is an example of a wireless communication system performing a transmission operation.

FIG. 3 is a schematic block diagram of a wireless transceiver device in accordance with some embodiments of the present disclosure.

FIG. 4 is an implementation of the processor in FIG. 3.

FIG. 5 is a flowchart of a transmission power control method in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

In the present disclosure, the wireless transceiver device may be implemented in various embodiments, including but not limited to, a mobile wireless transceiver device such as a station (STA), a notebook, a mobile phone, and a tablet, and/or a fixed wireless transceiver device such as an access point (AP), a router, a switch, a computer device, a server device, and a workstation. Furthermore, the wireless transceiver device may support multiple-input multiple-output (MIMO) transmissions, multiple-input single-output (MISO) transmissions, single-input multiple-output (SIMO) transmissions, and/or single-input single-output (SISO) transmissions.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes. The HT modes, the VHT modes, the HE modes, and the EHT modes correspond to various communication generations of wireless local area networks (WLANs) such as Wi-Fi 4, Wi-Fi 5, Wi-Fi 6, and Wi-Fi 7, respectively. More transmission modes are usable for a wireless transceiver device if the hardware specification thereof is better and the Wi-Fi system supported thereby is more advanced. The embodiments of the present disclosure also support other wired and/or wireless communication technologies such as cellular network, Bluetooth, local area network (LAN) and/or Universal Serial Bus (USB).

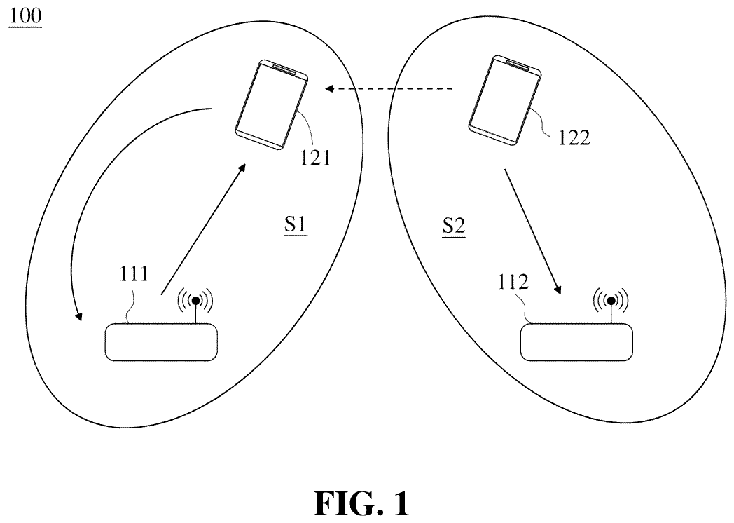

FIG. 1 is a schematic diagram of a wireless communication system in accordance with some embodiments of the present disclosure. The wireless communication system 100 includes wireless access point devices 111, 112, and wireless terminal devices 121, 122. The wireless communication system 100 supports the Wi-Fi system specifications, and the wireless access point devices 111, 112 and the wireless terminal devices 121, 122 may be APs and STAs in the Wi-Fi system specification, respectively. The wireless access point devices 111, 112 respectively provide wireless access services within a certain range, and the wireless terminal devices 121, 122 may respectively establish wireless communication connections with the wireless access point devices 111, 112 to access local area networks and/or wide area networks (e.g., Internet) via Wi-Fi channels (e.g., IEEE 802.11 channel). The wireless communication connection between the wireless access point devices 111 and the wireless terminal devices 121, and the wireless communication connections between the wireless access point devices 112 and the wireless terminal devices 122 may include, but not limited to, registration procedures, identity and access management procedures, establishment and release of wireless connections, and transmission and/or reception of control signals and/or data packets.

As shown in FIG. 1, the wireless access point device 111 and the wireless terminal device 121 constitute a BSS S1, and similarly the wireless access point device 112 and the wireless terminal device 122 constitute another BSS S2. The BSS S2 is an OBSS relative to the wireless access point device 111 and the wireless terminal device 121. Similarly, the BSS S1 is an OBSS relative to the wireless access point device 112 and the wireless terminal device 122. The wireless communication system 100 supports technologies such as spatial reuse and BSS coloring.

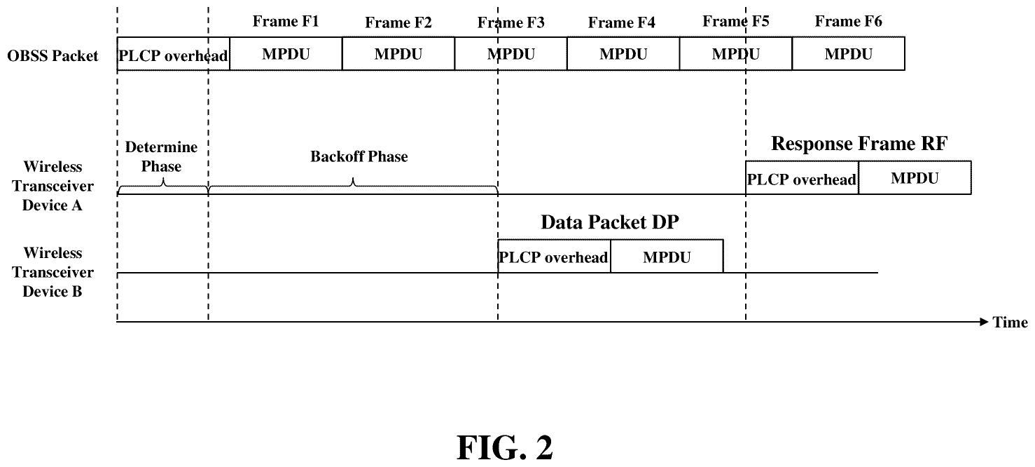

FIG. 2 is an example of a wireless communication system performing a transmission operation, in which the wireless transceiver devices A, B are respectively a STA and an AP in the same BSS. For example, the wireless transceiver devices A, B may respectively be the wireless terminal device 121 and the wireless access point device 111 (or respectively be the wireless terminal device 122 and the wireless access point device 112) in the wireless communication system 100 shown in FIG. 1, or alternatively a STA and an AP in the same BSS in another wireless communication system supporting technologies such as spatial reuse and BSS coloring. When detecting a physical protocol data unit (PPDU) packet (hereinafter referred to as “OBSS packet”) that is transmitted by a wireless transceiver device in the OBSS, the wireless transceiver device A enters a determination phase, and determines whether to perform an active spatial reuse transmission. If the active spatial reuse transmission is to be performed, the wireless transceiver device A enters a backoff phase from the determination phase. If detecting a data packet DP from the wireless transceiver device B of which the destination is the wireless transceiver device A itself before the backoff phase ends, the wireless transceiver device A pauses the backoff phase and receives the data packet DP, and transmits a response frame RF to the wireless transceiver device B in response to the data packet DP in a short inter-frame space (SIFS) after receiving the data packet DP. The operation of transmitting the response frame RF in response to the data packet DP before the backoff phase ends is also referred to as a passive space reuse transmission. In the example of FIG. 2, the OBSS packet includes a physical layer convergence procedure (PLCP) overhead (hereinafter referred to as “PLCP overhead”) and six media access layer protocol layer unit (MPDU) frames (hereinafter referred to as “MPDU frames”) F1-F6, and each of the data packet DP and the response frame RF includes a PLCP overhead and one MPDU frame. It is noted that the lengths of the OBSS packet, the data packet, and the response frame RF, and the number of MPDU frames are not limited to the example of FIG. 2.

According to the current Wi-Fi system specifications which supports technologies such as spatial reuse and BSS coloring, when the wireless transceiver device A detects an OBSS packet, the active transmission power TX_PWRₘₐₓ of the wireless transceiver device A for transmitting the frame is determined by Equation (1):

$${TX\_PWR}_{max} = \{ \begin{matrix}unconstrained , if {OBSS\_PD}_{level} \leq {OBSS\_PD}_{min} \\ {TX\_PWR}_{ref} - ( {OBSS\_PD}_{level} - {OBSS\_PD}_{min} )\end{matrix} , \qquad ( 1 )$$

$$if {OBSS\_PD}_{max} \geq {OBSS\_PD}_{level} > {OBSS\_PD}_{min} ,$$

where OBSS_PDₗₑᵥₑₗ represents the power detection parameter, OBSS_PDₘₐₓ represents the maximum power detection parameter, OBSS_PDₘᵢₙ. represents the minimum power detection parameter, and TX_PWR_{ref} represents the reference transmission power level. However, in Equation (1), the transmission of the response frame under a passive spatial reuse transmission is not considered, the response frame RF and the MPDU frames F5, F6 of the OBSS packet are likely to collide in a condition in which the transmission power of the response frame RF is too high, such that the signal-to-interference-plus-noise ratios (SINRs) of the response frame RF and the MPDU frames F5, F6 significantly decrease, which is likely to cause the wireless transceiver device B unable to successfully receive the response frame RF and the destination of the OBSS packet in the OBSS unable to successfully receive the MPDU frames F5, F6. In order to avoid the aforementioned collisions to ensure that the response frame RF and the MPDU frames F5, F6 in the OBSS packet can be successfully received, the adjustment of the transmission power of the response frame RF is to be performed by the wireless transceiver device A.

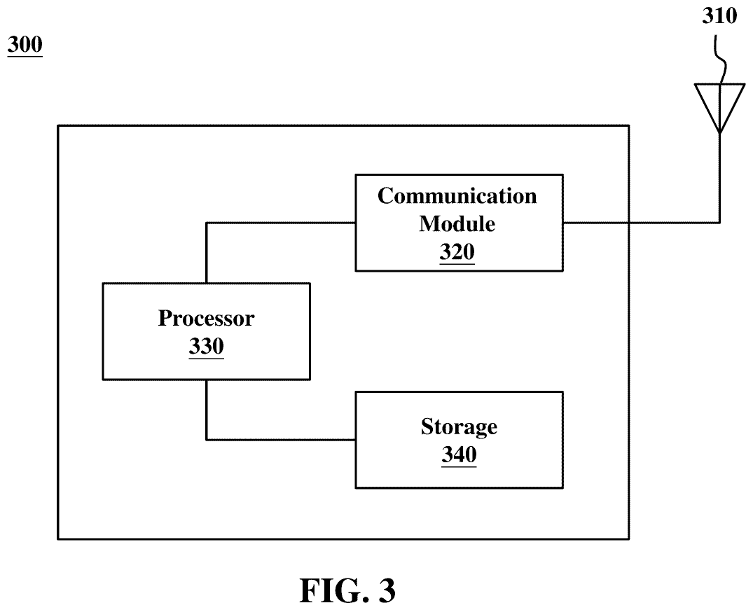

FIG. 3 is a schematic block diagram of a wireless transceiver device 300 in accordance with some embodiments of the present disclosure. The wireless transceiver device 300 may be any one of the wireless access point devices 111, 112 and the wireless terminal devices 121, 122. The wireless transceiver device 300 includes an antenna 310, a communication module 320, a processor 330, and a storage 340. The antenna 310 is arranged for transmitting and receiving radio frequency signals. In some embodiments, the wireless transceiver device 300 may include multiple antennas 310 that can be used to perform multiple-input and/or multiple-output radio frequency signal transmissions and receptions. The communication module 320 is coupled to the antenna 310, and is used for receiving and demodulating radio frequency signals into data packets as well as modulating data packets to be transmitted into radio frequency signals. The processor 330 is coupled to the communication module 320 and the storage 340, and is used to process data packets and determine the transmission mode of the communication module 320 to perform signal transmissions and receptions based on the system status and the communication protocol. The processor 330 may be, for example, a conventional processor, a multi-core processor, a digital signal processor (DSP), a microprocessor, or an application-specific integrated circuit (ASIC), but is not limited thereto. The storage 340 may be any data storage device that can be read and executed by the processor 330. The storage 340 may be, for example, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid state drive, a flash, or another data storage device suitable for storing bit data and/or program codes, but is not limited thereto.

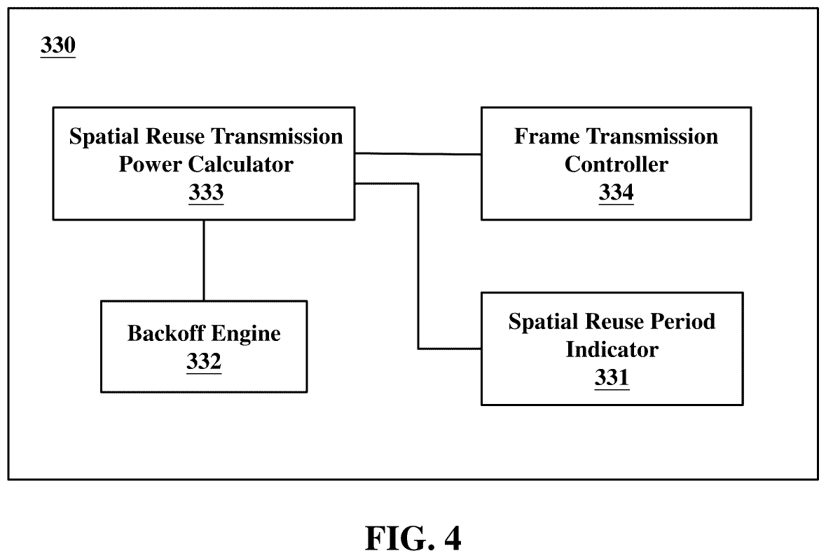

FIG. 4 is an implementation of the processor 330 in FIG. 3. Referring to FIG. 4, the processor 330 includes a spatial reuse period indicator 331, a backoff engine 332, a spatial reuse transmission power calculator 333, and a frame transmission controller 334. The spatial reuse period indicator 331 is used to determine whether the wireless transceiver device 300 can perform an active spatial reuse transmission. The backoff engine 332 is used to allow the wireless transceiver device 300 to enter the backoff phase and set a backoff timer when the spatial reuse period indicator 331 determines that the wireless transceiver device 300 can perform the active spatial reuse transmission. The spatial reuse transmission power calculator 333 is used to indicate the spatial reuse period indicator 331 to pause the backoff timer when a data packet is received before the backoff phase ends (the backoff timer does not expire yet), and calculate the transmission power for transmitting a response frame in response to the data packet according to the type of the data packet and the active transmission power TX_PWRₘₐₓ. The frame transmission controller 334 is used to control the communication module 320 to transmit the response frame with the transmission power of the response frame calculated by the spatial reuse transmission power calculator 333 in a short inter-frame space after the data packet is received.

The response frame may be an acknowledgement (ACK) response frame (hereinafter referred to as “ACK response frame”), which includes response frames such as acknowledgement, block acknowledgement (BA), and compressed block acknowledgement (C-BA), but is not limited thereto.

After pausing the backoff phase, the wireless transceiver device determines the minimum transmission power TPmin_resp of the response frame according to the content of the data packet, and determines the lower one of the minimum transmission power TPmin_resp and the active transmission power TX_PWRₘₐₓ as the passive transmission power of the response frame, as shown in Equation (2):

$$min ( TPmin\_resp , {TX\_PWR}_{max} ) . \qquad ( 2 )$$

According to Equation (2), if the active transmission power TX_PWRₘₐₓ is lower than the minimum transmission power TPmin_resp, the active transmission power TX_PWRₘₐₓ is determined as the passive transmission power of the response frame, and if the active transmission power TX_PWRₘₐₓ is higher than the minimum transmission power TPmin_resp, the minimum transmission power TPmin_resp is determined as the passive transmission power of the response frame. In the present disclosure, the minimum transmission power TPmin_resp of the response frame may be a constant, or may be dynamically adjusted.

If the minimum transmission power TPmin_resp of the response frame is a constant, for the response frame, any transmission power meeting the transmit error vector magnitude (TxEVM) thereof may be set to the minimum transmission power corresponding to this response frame may be set to. Thus, in a case in which the active transmission power TX_PWRₘₐₓ is too high, the passive transmission power of the response frame may be determined as the minimum transmission power TPmin_resp according to the response frame and Equation (2), in order to meet the TxEVM of the response frame.

Oppositely, if the minimum transmission power TPmin_resp of the response frame is to be dynamically adjusted, for the response frame, the initial value for the minimum transmission power TPmin_resp may be set to any transmission power that meets the TxEVM, and is determined as a threshold for dynamically adjusting the minimum transmission power according to the packet error rate (PER) obtained by the current transmission of the response frame after the spatial reuse transmission ends. The PER may be obtained by the following methods. As the MPDU frames in the data packet include a certain sequence number, the increase of the sequence number of the MPDU frames in the data packet received next time represents that the response frame is successfully received by the transmission terminal which sends the data packet. By recording the number of transmissions and the number of successful transmissions of the response frames, the PER of the wireless transceiver device for transmitting the response frames can be obtained.

For example, during the passive spatial reuse period and the passive transmission power of the response frame being the minimum transmission power TPmin_resp, if the current PER is higher than the threshold (e.g., higher than 0), the minimum transmission power TPmin_resp corresponding to the response frame may be adjuster higher without exceeding the TxEVM for at least a subsequent passive spatial reuse transmission before the backoff phase ends (e.g., the next spatial reuse transmission after the current passive spatial reuse transmission). The minimum transmission power TPmin_resp is reset to the initial value after the active spatial reuse transmission completes following the backoff phase (the backoff timer has expired). After the backoff phase ends, the wireless transceiver device performs the active spatial reuse transmission with the active transmission power TX_PWRₘₐₓ.

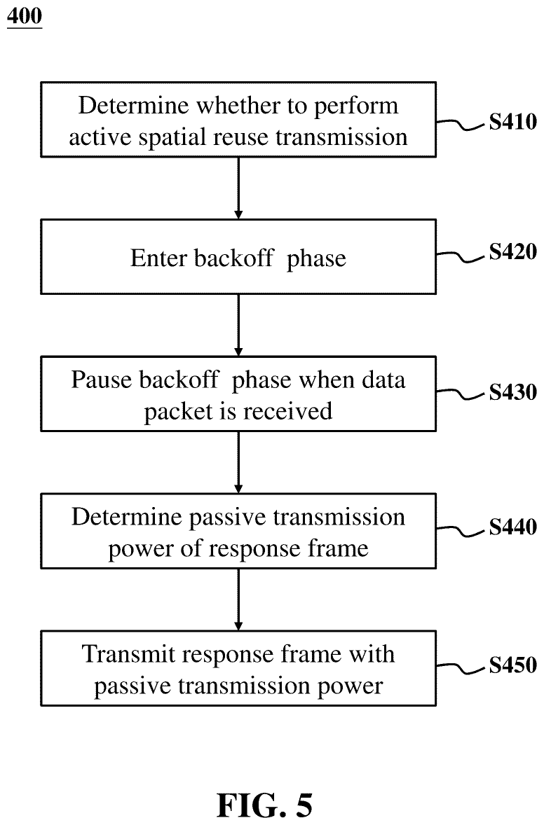

FIG. 5 is a flowchart of the transmission power control method 400 in accordance with some embodiments of the present disclosure. The transmission power control method 400 is adapted to the wireless access point devices 111, 112, the wireless terminal devices 121, 122 in the wireless communication system 100, and/or another wireless transceiver device supporting technologies such as spatial reuse and BSS coloring. The transmission power control method 400 is performed by the wireless transceiver device when detecting an OBSS packet. First, Operation S410 is performed to determine whether to perform an active spatial reuse transmission. When determining that the active spatial reuse transmission is to be performed, Operation S420 is performed to calculate the active transmission power TX_PWRₘₐₓ by Equation (1) and enter the backoff phase. The obtained active transmission power TX_PWRₘₐₓ may be stored into the storage (e.g., the storage 340 in the wireless transceiver device 300) for subsequent operations. Then, Operation S430 is performed to pause the backoff phase and determine the type of the response frame in response to the data packet according to the data packet when the data packet of which the destination is the wireless transceiver device itself is received before the backoff phase ends. Next, Operation S440 is performed to determine the passive transmission power of the response frame by Equation (2) according to the type of the response frame and the active transmission power TX_PWRₘₐₓ. Similarly, the determined passive transmission power may be stored into the storage (e.g., the storage 340 in the wireless transceiver device 300) for subsequent operations. After that, Operation S450 is performed to transmit the response frame with the passive transmission power and restore the backoff phase after the transmission of the response frame completes. If the minimum transmission power TPmin_resp of the response frame can be dynamically adjusted, Operation S450 may be performed to further determine whether to adjust the minimum transmission power TPmin_resp of the response frame according to the PER obtained by transmitting the response frame for the subsequent passive spatial reuse transmission in the same backoff phase.

Summing up the above, the present disclosure provides a wireless transceiver device which includes a communication module and a processor. The communication module is used for transmitting and receiving radio frequency signals, and the processor is coupled to the communication module and performs the following operations: determining whether to perform an active spatial reuse transmission when detecting an OBSS packet; entering a backoff phase when determining that the active spatial reuse transmission is to be performed; pausing the backoff phase when detecting a data packet of which a destination is the wireless transceiver device before the backoff phase ends, and receiving the data packet; determining a lower one of a minimum transmission power of a response frame in response to the data packet and an active transmission power corresponding to the wireless transceiver device as a passive transmission power of the response frame; and transmitting the response frame with the passive transmission power in a short inter-frame space after the data packet is received. In some embodiments, the response frame is an acknowledgement response frame. In some embodiments, the minimum transmission power is a constant. In some embodiments, the processor further performs the following operation: adjusting the minimum transmission power for at least a subsequent passive spatial reuse transmission before the backoff phase ends based on a PER obtained by transmitting the response frame when the passive transmission power is the minimum transmission power corresponding to the response frame. In some embodiments, the processor further performs the following operation: resetting the minimum transmission power to an initial value after the backoff phase ends. In some embodiments, the processor further performs the following operation: performing the active spatial reuse transmission with the active transmission power after the backoff phase ends. In some embodiments, the wireless transceiver device further includes a storage used for storing the active transmission power and the passive transmission power.

Summing up the above, the present disclosure also provides a transmission power control method adapted to a wireless transceiver device. The transmission power control method includes: determining whether to perform an active spatial reuse transmission when detecting an OBSS packet; entering a backoff phase when determining that the active spatial reuse transmission is to be performed; pausing the backoff phase when detecting a data packet of which a destination is the wireless transceiver device before the backoff phase ends, and receiving the data packet; determining a lower one of a minimum transmission power of a response frame in response to the data packet and an active transmission power corresponding to the wireless transceiver device as a passive transmission power of the response frame; and transmitting the response frame with the passive transmission power in a short inter-frame space after the data packet is received. In some embodiments, the response frame is an acknowledgement response frame. In some embodiments, the minimum transmission power is a constant. In some embodiments, the transmission power control method further includes: adjusting the minimum transmission power for at least a subsequent passive spatial reuse transmission before the backoff phase ends based on a PER obtained by transmitting the response frame when the passive transmission power is the minimum transmission power corresponding to the response frame. In some embodiments, the transmission power control method further includes: resetting the minimum transmission power to an initial value after the backoff phase ends. In some embodiments, the transmission power control method further includes: performing the active spatial reuse transmission with the active transmission power after the backoff phase ends.

Summing up the above, the present disclosure also provides a wireless communication system which includes: a first wireless transceiver device and a second wireless transceiver device. The second wireless transceiver device is communicatively connected to the first wireless transceiver device, and constitutes a BSS with the first wireless transceiver device, and performs the following operations: determining whether to perform an active spatial reuse transmission when detecting an OBSS packet; entering a backoff phase when determining that the active spatial reuse transmission is to be performed; pausing the backoff phase when detecting a data packet from the first wireless transceiver device before the backoff phase ends, and receiving the data packet; determining a lower one of a minimum transmission power of a response frame in response to the data packet and an active transmission power corresponding to the second wireless transceiver device as a passive transmission power of the response frame; and transmitting the response frame to the first wireless transceiver device with the passive transmission power in a short inter-frame space after the data packet is received. In some embodiments, the first wireless transceiver device is a wireless access point device, and the second wireless transceiver device is a wireless terminal device. In some embodiments, the response frame is an acknowledgement response frame. In some embodiments, the minimum transmission power is a constant. In some embodiments, the second wireless transceiver device further performs the following operation: adjusting the minimum transmission power for at least a subsequent passive spatial reuse transmission before the backoff phase ends based on a PER obtained by transmitting the response frame when the passive transmission power is the minimum transmission power corresponding to the response frame. In some embodiments, the second wireless transceiver device further performs the following operation: resetting the minimum transmission power to an initial value after the backoff phase ends. In some embodiments, the second wireless transceiver device further performs the following operation: performing the active spatial reuse transmission with the active transmission power after backoff phase ends.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless transceiver device, comprising:
a communication module used for transmitting and receiving radio frequency signals; and
a processor coupled to the communication module and configured to perform the following operations:
determining whether to perform an active spatial reuse transmission when detecting an overlapped basic service set (OBSS) packet;
entering a backoff phase when determining that the active spatial reuse transmission is to be performed;
pausing the backoff phase when detecting a data packet of which a destination is the wireless transceiver device before the backoff phase ends, and receiving the data packet;
determining a lower one of a minimum transmission power of a response frame in response to the data packet and an active transmission power corresponding to the wireless transceiver device as a passive transmission power of the response frame; and
transmitting the response frame with the passive transmission power in a short inter-frame space (SIFS) after the data packet is received.

2. The wireless transceiver device of claim 1, wherein the response frame is an acknowledgement (ACK) response frame.

3. The wireless transceiver device of claim 1, wherein the minimum transmission power is a constant.

4. The wireless transceiver device of claim 1, wherein the processor is configured to further perform the following operation:
adjusting the minimum transmission power for at least a subsequent passive spatial reuse transmission before the backoff phase ends based on a packet error rate (PER) obtained by transmitting the response frame when the passive transmission power is the minimum transmission power corresponding to the response frame.

5. The wireless transceiver device of claim 4, wherein the processor is configured to further perform the following operation:
resetting the minimum transmission power to an initial value after the backoff phase ends.

6. The wireless transceiver device of claim 1, wherein the processor is configured to further perform the following operation:
performing the active spatial reuse transmission with the active transmission power after the backoff phase ends.

7. The wireless transceiver device of claim 1, further comprising:
a storage configured to store the active transmission power and the passive transmission power.

8. A transmission power control method adapted to a wireless transceiver device, the transmission power control method comprising:
determining whether to perform an active spatial reuse transmission when detecting an OBSS packet;
entering a backoff phase when determining that the active spatial reuse transmission is to be performed;
pausing the backoff phase when detecting a data packet of which a destination is the wireless transceiver device before the backoff phase ends, and receiving the data packet;
determining a lower one of a minimum transmission power of a response frame in response to the data packet and an active transmission power corresponding to the wireless transceiver device as a passive transmission power of the response frame; and
transmitting the response frame with the passive transmission power in a short inter-frame space after the data packet is received.

9. The transmission power control method of claim 8, wherein the response frame is an acknowledgement response frame.

10. The transmission power control method of claim 8, wherein the minimum transmission power is a constant.

11. The transmission power control method of claim 8, further comprising:
adjusting the minimum transmission power for at least a subsequent passive spatial reuse transmission before the backoff phase ends based on a PER obtained by transmitting the response frame when the passive transmission power is the minimum transmission power corresponding to the response frame.

12. The transmission power control method of claim 11, further comprising:
resetting the minimum transmission power to an initial value after the backoff phase ends.

13. The transmission power control method of claim 8, further comprising:
performing the active spatial reuse transmission with the active transmission power after the backoff phase ends.

14. A wireless communication system comprising:
a first wireless transceiver device; and
a second wireless transceiver device communicatively connected to the first wireless transceiver device, constituting a basic service set (BSS) with the first wireless transceiver device, and configured to perform the following operations:
determining whether to perform an active spatial reuse transmission when detecting an OBSS packet;
entering a backoff phase when determining that the active spatial reuse transmission is to be performed;
pausing the backoff phase when detecting a data packet from the first wireless transceiver device before the backoff phase ends, and receiving the data packet;
determining a lower one of a minimum transmission power of a response frame in response to the data packet and an active transmission power corresponding to the second wireless transceiver device as a passive transmission power of the response frame; and
transmitting the response frame to the first wireless transceiver device with the passive transmission power in a short inter-frame space after the data packet is received.

15. The wireless communication system of claim 14, wherein the first wireless transceiver device is a wireless access point device, and the second wireless transceiver device is a wireless terminal device.

16. The wireless communication system of claim 14, wherein the response frame is an acknowledgement response frame.

17. The wireless communication system of claim 14, wherein the minimum transmission power is a constant.

18. The wireless communication system of claim 14, wherein the second wireless transceiver device is configured to further perform the following operation:
adjusting the minimum transmission power for at least a subsequent passive spatial reuse transmission before the backoff phase ends based on a PER obtained by transmitting the response frame when the passive transmission power is the minimum transmission power corresponding to the response frame.

19. The wireless communication system of claim 18, wherein the second wireless transceiver device is configured to further perform the following operation:
resetting the minimum transmission power to an initial value after the backoff phase ends.

20. The wireless communication system of claim 14, wherein the second wireless transceiver device is configured to further perform the following operation:
performing the active spatial reuse transmission with the active transmission power after backoff phase ends.
